(19) United States
(12) Patent Application Publication
(10) Pub. No.: US 2015/0102691 A1
(43) Pub. Date: Apr. 16, 2015

(54) SAFETY CIRCUIT FOR THE EXPLOSION-PROOF CASING AND METHOD OF OPERATING SAID SAFETY CIRCUIT

(71) Applicant: R. STAHL Schaltgerate GmbH, Waldenburg (DE)

(72) Inventor: Ralf Kollreutter, Heilbronn (DE)

(21) Appl. No.: 14/510,870

(22) Filed: Oct. 9, 2014

(30) Foreign Application Priority Data
Oct. 10, 2013 (DE) 10 2013 111 212.9

(51) Int. Cl. H02J 7/00

(52) U.S. Cl. CPC H02J 7/0029; H02J 7/007; H02J 7/345
USPC 307/328

(57) ABSTRACT

The invention relates to a safety circuit (10) for use in an explosion-proof casing (12). The safety circuit (10) is disposed for discharging a capacitor arrangement comprising at least one capacitor (19) that is associated with an electrical operating means (11). The at least one capacitor (19) is discharged, in a defined manner, via the safety circuit (10) through an electrical discharge circuit (33) during a discharge time period (ET), after a supply voltage (UV) on a power supply input (13) is switched off. At the end of the discharge time duration (ET), the electrical charge or the electrical energy of the at least one capacitor (19) is sufficiently low, so that an ignition of the potentially explosive atmosphere in the environment of the explosion-proof casing (12) is precluded.

The invention relates to a safety circuit for the use in or with an explosion-proof casing, as well as to a method of operating the safety circuit. In particular, the explosion-proof casing is a pressure-resistant encapsulation (Ex-d) or a pressurized encapsulation. Accommodated in the casing are electrical operating means that may represent an ignition source for a potentially explosive atmosphere. Due to the protection featured by the explosion-proof casing, such operating means can be operated even in environments that include potentially explosive atmospheres. The casing ensures that the electrical operating means cannot cause an ignition of the potentially explosive atmosphere.

The electrical operating means in the casing may comprise capacitors. In conjunction with this, it is a problem that an electrical energy in the capacitor may continue to be stored even after the supply voltage for the electrical operating means has been switched off. Opening the casing in the potentially explosive atmosphere can create a dangerous condition if the electrical energy stored in the capacitor is still too high. In a potentially explosive atmosphere the casing must only be opened after the capacitor has sufficiently discharged.

As a rule, however, the capacitor charge level is not known. Depending on its design and depending on its exterior circuitry, the self-discharge of the capacitor can take very long. Frequently, information on electrical operating means and discharge times of the capacitors that are used are not or only difficultly available. This can lead to restrictions in the selection of operating means that can be used in explosion-proof casings. These disadvantages shall be eliminated by the present invention. It may now be viewed as the object of the invention that a safety circuit is provided for the explosion-proof casing or for the electrical operating means comprising at least one capacitor accommodated therein, said safety circuit ensuring an improved use with high safety.

In accordance with the invention, the safety circuit comprises a control unit. The control unit is connected to a power supply input where a supply voltage can be made available.

The supply voltage, for example, may be a mains voltage or an output voltage of a supply device. For example, considering casings with pressure-resistant encapsulation, the supply voltage is made available by a supply device after the mains voltage is switched on only if the casing is in the state of pressure-resistant encapsulation, i.e., after the interior of the casing has been rinsed with an inert gas. The supply device may also be made available to other casings, i.e., also directly after the application of the mains voltage. In addition, the supply device may comprise a converter in order to convert the mains voltage into a DC or AC voltage suitable for the operating means. In so doing, the supply voltage may always be available whenever the mains voltage is also available or only when the casing is in explosion-proof state. In both cases, it is possible to optionally provide a supply device for making the supply voltage available.

The explosion-proof casing accommodates at least one electrical operating mans. The electrical operating means comprises a capacitor, or a capacitor is allocated to the electrical operating means. For example, the electrical operating means may be a voltage supply device or an electric motor. In principle, the inventive safety circuit can be used for all the electrical operating means that comprise at least one capacitor or that are associated with at least one capacitor. The capacitor charges to a capacitor voltage. Depending on the application, charging of the capacitor may take place already when a supply voltage is applied to the power supply input. Alternatively, the capacitor can be charged to capacitor voltage only when the associate electrical operating means is switched on or operated. This depends on how the capacitor is electrically connected to the power supply input.

The safety circuit comprises a series circuit including a controlled switch and a discharge resistor. The series circuit is connected to the at least one capacitor, forming an electrical discharge circuit with said capacitor. In a disconnected position, the controlled switch interrupts a passable electrical connection in the electrical discharge circuit, so that no discharge current can flow from the capacitor through the discharge resistor. In a closed position, the electrical discharge circuit is electrically closed and the at least one capacitor can be discharged by means of a discharge current through the discharge resistor.

The control unit is disposed to switch the controlled switch into the closed position after the supply voltage has been switched off in order to discharge the at least one capacitor. The control unit recognizes the switching off or the absence of the supply voltage through its electrical connection with the power supply input. Switching off the supply voltage alone does not lead directly to a safe, non-hazardous state of the electrical operating means or of the capacitor. Therefore, the electrical discharge circuit is closed first and the capacitor discharged. The casing may be opened by an operator only after the expiration of a discharge time. The discharge time can be determined as a function of the capacitance of the capacitor, the level of the ohmic resistance of the discharge resistor, the capacitor voltage, the maximum permissible discharge current and/or additional parameters. The level of ohmic resistance can be prespecified as a function of the permissible temperature of the at least one capacitors or the components in the electrical discharge circuit. Upon expiration of the discharge time it is ensured that the residual energy stored in the capacitor is sufficiently low to preclude an ignition of the potentially explosive atmosphere. Now the casing may be opened.

In so doing, it is also possible to indicate to the operator the progression of the discharge time by an indicating means, for example, visually and/or acoustically. Additionally or alternatively, there is also the option of releasing a locking device only after the expiration of the discharge time so that a previous opening of the casing is prevented. In the simplest case, a waiting period beginning with the switch-off of the mains or supply voltage may be indicated on the casing to the operator, after which waiting period the casing may be opened. In conjunction with this, the waiting period is at least as long as the discharge time, depending on whether the discharge of the at least one capacitor occurred instantaneously after the mains or supply voltage was switched off.

The discharge resistor is preferably an ohmic resistor. Fundamentally, however, it is also possible to use other components or a combination of several components that exhibit an ohmic resistance.

Preferably, the control unit is disposed to switch the controlled switch after switching off the mains voltage only after a switching condition has been satisfied. For example, one switching condition may be the presence of a feedback signal of the electrical operating means and/or a prespecified delay time duration after the supply voltage was switched off. In particular, this is advantageous whenever the at least one capacitor is allocated a voltage supply device, said device being disposed to ensure an uninterrupted voltage supply of a further electrical operating means that is to be supplied. After switching off the supply voltage the electrical operating means that is to be supplied will continue to be supplied with sufficient electrical energy by the voltage supply device. In particular, this may be necessary when the electrical operating means to be supplied must be brought into a defined and/or visible operating state after the supply voltage was switched off or lost. The time period required therefor can be prespecified and used as the delay time duration so that the switching condition is satisfied only after expiration of this delay time duration. Only then will the control unit ensure that the controlled switch will switch into its closed position in order to discharge the at least one capacitor. Alternatively or additionally, the electrical operating means can indicate to the control unit via the feedback signal that a continued supply with electrical energy is no longer required, e.g., when a safe or defined state was achieved. The presence of such a feedback signal can thus be necessary or sufficient for satisfying the switching condition.

Alternatively, it is also possible to switch the controlled switch instantaneously into its closed position after switching off the supply voltage if the at least one capacitor is not needed for an additional supply of electrical energy to the electrical operating means.

In a preferred exemplary embodiment, the control unit is disposed to instantaneously switch the controlled switch into the disconnected position after switching on the supply voltage. As a result of this, a charging of the at least one capacitor becomes possible immediately after the supply voltage is switched on.

The term “instantaneously” is understood to mean a chronological sequence that does not comprise any additional dead times or intentionally prespecified delays but comprises only such delays that necessarily result due to the employed technical means.

It is advantageous if the control unit comprises a relay. In conjunction with this, the controlled switch may comprise the operating or load contacts of the relay, in which case the switching position of said relay is controlled by the control component.

In one exemplary embodiment the relay may be, in particular, a time-controlled relay. Preferably, the time-controlled relay is embodied as a drop-delayed relay that deenergizes with a time delay, after switching off a voltage on the control part of the relay. Energizing of the relay may occur instantaneously after the application of a voltage to the control part.

In a preferred exemplary embodiment, the at least one capacitor is a component of an electrical operating means that is a voltage supply device. In conjunction with this, several capacitors are provided in particular, these being connected in series and/or in parallel relative to each other and forming a capacitor bank. The voltage supply device is preferably configured as an uninterruptible voltage supply, wherein the at least one capacitor acts as an energy buffer storage for an electrical operating means that is to be supplied and that is connected to the voltage supply device.

In a preferred exemplary embodiment, the discharging of the at least one capacitor, after switching off the supply voltage and/or after satisfying a switching condition, can be controlled or regulated as a function of parameters. For example, the discharge current in the electrical discharge circuit and/or the temperature of the at least one capacitor and/or the capacitor voltage can act as parameters for discharge control or regulation. For example, the discharge resistor may be configured as a temperature-dependent resistor that is thermally coupled with the at least one capacitor. In this manner, the discharge current can be adjusted as a function of the temperature of the capacitor.

It is also possible to provide an electric motor with a starting capacitor as the operating means. The at least one capacitor can thus represent the starting capacitor of the electric motor. The starting capacitor is used only for starting the motor and can be at least partially charged at the end of the starting phase. As described hereinabove, such a capacitor can be discharged via the safety circuit.

Advantageous embodiments of the invention can be inferred from the dependent patent claims, the description as well as the drawings. Hereinafter exemplary embodiments of the invention will be explained in detail with reference to the attached drawings. They show in

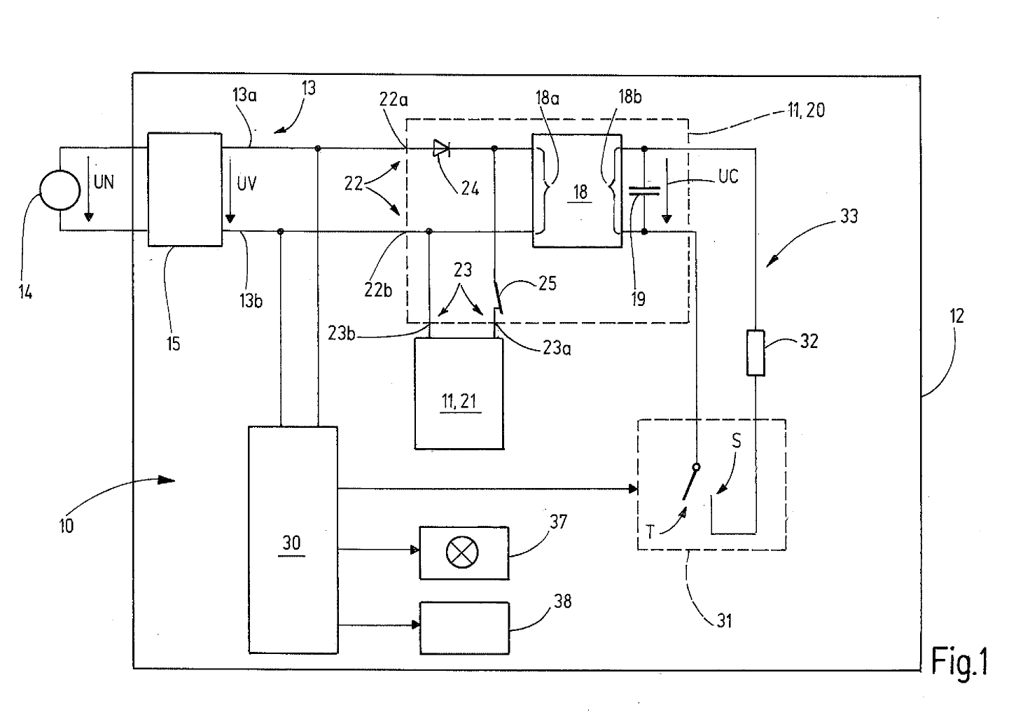

FIGS. 1 to 4 block circuit diagrams of a exemplary embodiments of safety circuits for an electrical operating means in an explosion-proof casing;

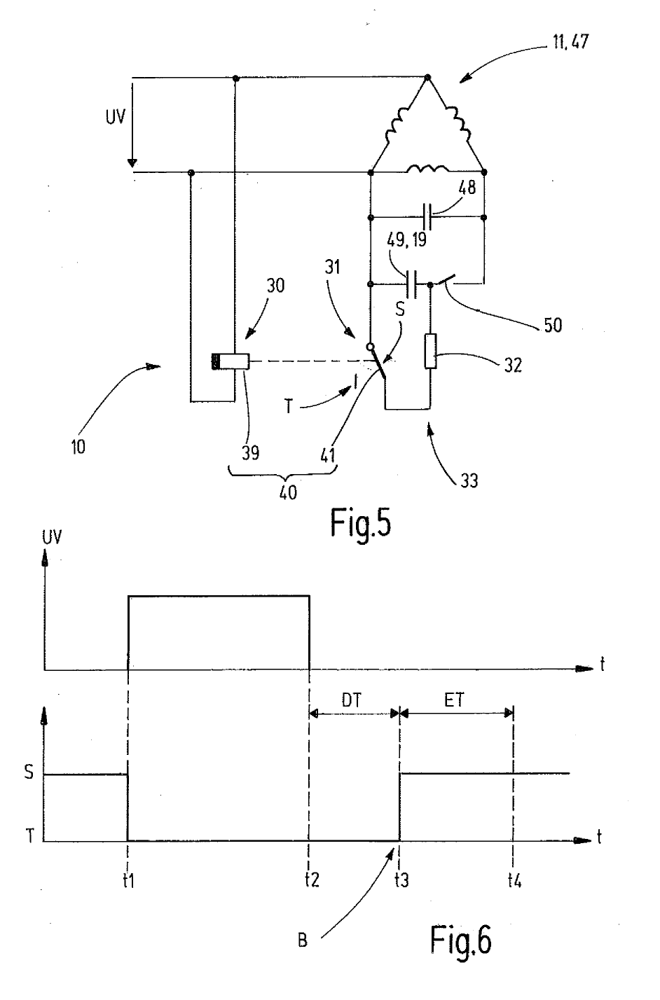

FIG. 5 a block circuit diagram representing an electrical operating means comprising an electric motor or a starting capacitor, as well as an embodiment of a safety circuit; and

FIG. 6 a schematic diagram of the switching of a controlled switch of the safety circuit in chronological reference to the switching-on and switching-off of a supply voltage for the explosion-proof casing or for the electrical operating means.

FIG. 1 shows a block circuit diagram of a first exemplary embodiment of a safety circuit 10 for at least one electrical operating means 11 that is arranged, together with the safety circuit 10, in an explosion-proof casing 12. On principle, the explosion-proof casing 12 may be embodied in any type of ignition protection. In the exemplary embodiment, the casing 12 is embodied in the type of ignition protection of a pressure-resistant encapsulation (Ex-d) or a pressurized encapsulation (Ex-p).

For the supply of the electrical operating means 11 with electrical energy, a power supply input 13 is provided on or in the casing 12. The power supply input 13, in accordance with the example, comprises a first power supply connection 13a, as well as a second power supply connection 13b. A supply voltage UV may be provided on the power supply input 13 and, in accordance with the example, between the two power supply connections 13a, 13b. The supply voltage UV, for example, can be provided either directly by a mains voltage UN of a mains voltage source 14, so that a supply voltage UV is made available when the mains voltage UN is available. As an alternative thereto, a supply device 15 may be interposed between the mains voltage source and the power supply input 13. For example, in explosion-proof casings 12 in the form of pressurized encapsulations, the power supply device 15 provides the supply voltage UV only when the casing 12 is in the state of the pressurized encapsulation, after the casing interior has been rinsed with an inert gas. The power supply device 15 can, alternatively or additionally, also be used for the conversion of the mains voltage UN into a DC voltage, or a single-phase or multi-phase AC voltage as the supply voltage UV.

Consequently, such a supply device 15 is not required for all types of ignition protection of the casing 12 or all electrical operating means 11 and is thus optional.

At least one of the electrical operating means 11 accommodated in the casing 12 comprises a capacitor 19. In the exemplary embodiment in accordance with FIG. 1, one of the electrical operating means 11 is configured as a voltage supply device 20 and, in accordance with the example, as an uninterruptible voltage supply device. In so doing, the at least one capacitor 19 acts as the buffer storage for the electrical energy for the supply of an electrical load 21 that, therefore, represents an electrical operating means 11 that is to be supplied in the casing 12.

FIG. 1 shows the voltage supply device 20 only schematically with one capacitor 19. As a rule, a capacitor bank is used, it comprising several serially and/or parallely connected individual capacitors. The illustrated capacitor 19 is to be viewed only symbolically for one or more capacitors that are connected in series and/or in parallel relative to each other.

For example, the voltage supply device 20 can comprise a converter 18 that, depending on the case of use, may have any converter topology. In accordance with the example, the converter 18 is configured as a bidirectional converter. In the exemplary embodiment in accordance with FIG. 1, the power supply device 15 provides a DC voltage as the supply voltage UV. In this case, the converter 18 is configured as a DC-DC converter.

The voltage supply device 20 has a first input 22 that is electrically connected to the power supply input 13. In the exemplary embodiment, the input 22 has a first input connection 22a that is connected to the first power supply connection 13a. A second input connection 22b of the input 22 is connected to the second power supply connection 13b. the load 21 is connected to an output 23 of the voltage supply device 20. The output 23 is electrically connected to the input 22. In accordance with the example, the second input connection 22b is directly connected to a second output connection 23b of the output 23, so that the two connections 22b, 23b are on the same electrical potential. The first input connection 22a is connected to a first output connection 23a of the output 23 via a diode 24 and a load switch 25. Furthermore, the converter 18 having the first converter connections 18a is electrically connected to the input 22 and the output 23. In accordance with the example, the first input connection 22a is connected to one of the two first converter connections 18a via the diode 24. The other of the first converter connections 18a is on the same potential as the second input connection 22b and the second output connection 23b. The at least one capacitor 19 is connected to the second converter connections 18b. The converter 18 operates bidirectionally. The latter is able to charge the at least one capacitor 19 with a supply voltage UV applied to the input 22, so that a capacitor voltage UC is applied to the at least one capacitor 19. With the supply voltage UV switched off, the converter 18 can provide a voltage for the load 21 by discharging the at least one capacitor 19 on its first converter connections 18a. Consequently, the load 21 can be supplied at least for some time with electrical energy from the at least one capacitor 19, once the supply voltage UV is switched off.

The safety circuit 10 allocated to the electrical operating means 11 comprises a control unit 30. The control unit 30 is connected to the power supply input 13. As a result of this, the control unit 30 can determine whether the supply voltage UV has been made available or not, namely, whether the supply voltage UV is switched on or switched off. A switch-off of the power supply voltage UV can either be due to the fact that the mains voltage UN is not available or, provided a supply device 15 is provided, that the power supply device 15 does not make available a supply voltage UV. This may be caused by a defect in the supply device 15 or in a pressure-encapsulated casing 12 if the condition of pressure encapsulation does not exist.

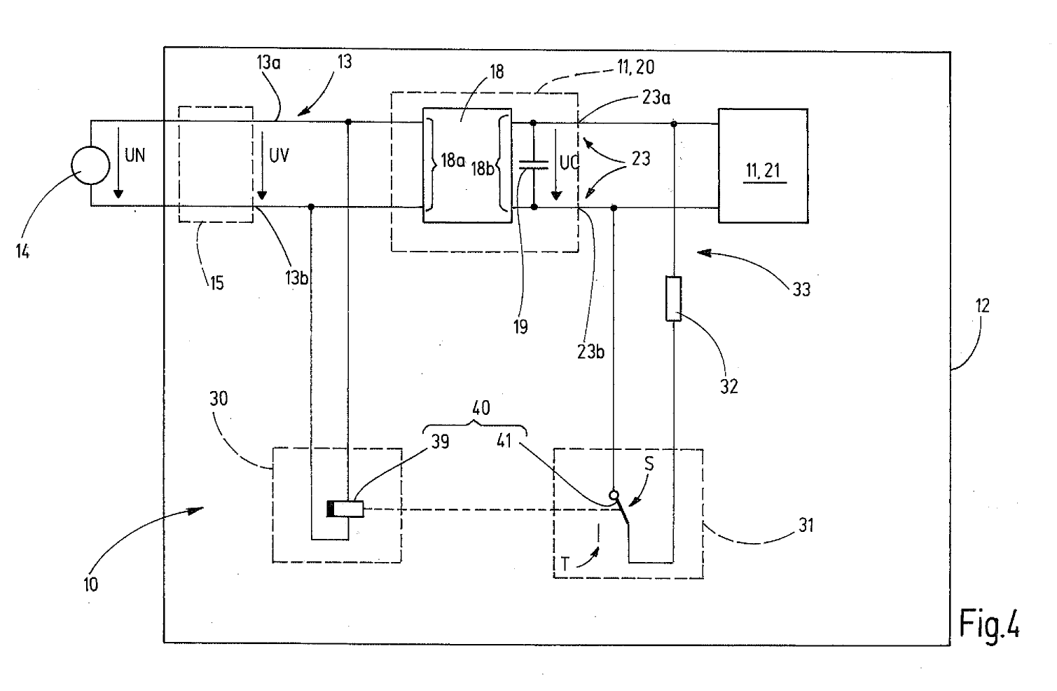

The control unit 30 activates a controlled switch 31. The controlled switch 31 can be switched between a closed position S and a disconnected position T by means of a control the control unit 30. FIG. 1 shows the disconnected position T, whereas FIGS. 4 through 4, show the closed position S of the controlled switch 31, for example. The controlled switch is connected in series with the discharge resistor 32. This series connection comprising the controlled switch 31 and the discharge resistor 32 is connected to the two connections of the at least one capacitor 19 and forms an electrical discharge circuit 33, together with the at least one capacitor 19. In disconnected position T, the electrical discharge circuit 33 is interrupted so that the at least one capacitor 19 cannot be discharged via the discharge resistor 32 and that no discharge current will flow. If the controlled switch 31 is in its closed position S, the electrical discharge circuit 33 is closed and the at least one capacitor 19 is discharged by a discharge current flowing in the electrical discharge circuit 33.

Hereinafter, the function of the safety circuit 10 in accordance with the exemplary embodiment of FIG. 1 will be explained with reference to FIG. 6.

To begin with, it is assumed that no supply voltage UV is provided to the power supply input 13. The controlled switch 31 is in an inoperative position that corresponds to the closed position S. At a first point in time t1, the supply voltage UV on the power supply input 13 is switched on, for example, by the power supply device 15 or by the provision of a mains voltage UN. The control unit 30 detects the provision of the supply voltage UV and instantaneously switches the controlled switch 31 into its disconnected position T. The instantaneous switching is to be understood to mean that switching takes place without any wanted time delay. However, depending on the technical means that are used, switching may require a certain period of time.

If the controlled switch 31 is in its disconnected position T, the at least one capacitor 19 can be charged to a capacitor voltage UC via the electrical energy provided on the power supply input 13. In the exemplary embodiment, this occurs via the converter 18. With the supply voltage UV being available, the load 21 is supplied directly via the electrical energy on the power supply input 13, independently of the converter 18 or the at least one capacitor 19.

Furthermore, it is assumed that the supply voltage UV is switched off at a second point in time t2. Depending on what kind of operating means 11 the electrical load 21 is, it may be necessary to maintain the power supply of the load 21 with electrical energy for a prespecified time period in order to bring the load 21 into a defined or safe state. For this purpose, the voltage supply device 20 provides electrical energy from the at least one capacitor 19 for the load 21 after the supply voltage UV was switched off. In order not to jeopardize the energy supply of the load 21 after switching off the supply voltage UV, the control unit 30, after detecting that the supply voltage UV was switched off, does not immediately switch the controlled switch 31 to the closed position S but only when a prespecified switching condition B has been satisfied. For example, the switching condition B may be satisfied if a prespecified delay time duration DT has expired since the detection of the switch-off of the supply voltage UV. After the switching condition B has been satisfied, the control unit 30 switches the controlled switch 31 from the disconnected position T into the closed position S, this being done at a third point in time t3 in accordance with FIG. 6.

Upon expiration of the prespecified delay time duration DT at the third point in time t3, the load 21 can be disconnected from the supply with electrical energy by the at least one capacitor 19 by opening the load switch 25.

The electrical discharge circuit 33 is closed as of the third point in time t3, and the at least one capacitor 19 is discharged via a discharge current through the discharge resistor 32. The discharge duration ET that is required to reduce the electrical energy stored in the at least one capacitor 19 to a level that allows the non-hazardous opening of the housing 12 in the potentially explosive atmosphere can be determined by means of characteristic electrical values of the components in the electrical discharge circuit 33. This discharge duration ET, for example, is a function of the maximum capacitor voltage UC, the ohmic resistance value of the discharge resistor 32, the maximum permissible discharge current, the self-discharge of the at least one capacitor 19, the capacitance of the at least one capacitor 19 and further parameters. The discharge duration ET starts with the switching of the controlled switch 31 into the closed position S at the third point in time t3 and stops at the fourth point in time t4. After the fourth point in time t4 the casing 12 can be opened without danger. The electrical energy stored and potentially still present in the at least one capacitor 19 is sufficiently low to preclude an ignition of the potentially explosive atmosphere outside the explosion-proof casing 12.

The time that has to elapse in order to be able to open the casing 12 without danger after the supply voltage UV was switched off can be provided in the form of information on the outside of the casing 12. In the exemplary embodiment, this time period is represented by the sum of the delay time duration DT and the discharge duration ET.

Alternatively or additionally, the end of the discharge duration ET at the fourth point in time t4 can also be indicated to the operator, for example acoustically and/or visually. The safety circuit 10 may optionally comprise an appropriate indicating means 37 that is activated by the control unit 30. Alternatively or additionally, the control unit 30 can also activate a locking means 38. By means of the locking means 38, it is possible to lock a door, a flap, a lid or the like of the casing 12 that can be released only when the discharge duration ET has expired.

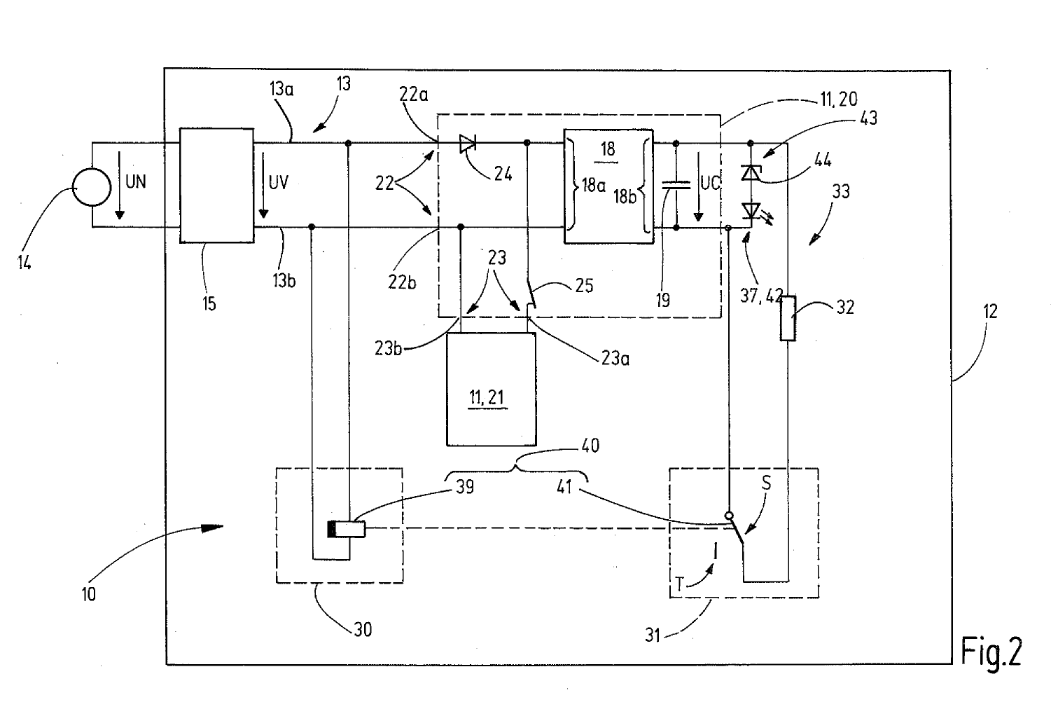

FIG. 2 shows a further exemplary embodiment of the safety circuit 10. The exemplary embodiment according to FIG. 2 substantially corresponds to the exemplary embodiment according to FIG. 1, as explained hereinabove. To this extent, only the difference will be discussed in detail hereinafter and, other than that, reference is made to description hereinabove.

In the exemplary embodiment according to FIG. 2, the control unit 30 is the control part 39 of a relay. The operating contacts 41 of this relay 40 form the controlled switch 31. In a conventional electromagnetic relay 40, the control part 39 comprises a spool that actuates the operating contacts 41 via an armature.

As indicated in the block circuit diagram of relay 40 in FIG. 2, this is a time-controlled relay 40 that, in the case of the exemplary embodiment, is drop-off delayed. When a supply voltage UV is applied, the controlled switch 31 is switched into and held in its disconnected position T. If no supply voltage UV is applied to the control part 39 of the relay 40, the controlled switch 31 or the operating contacts 41 are not switched immediately, but time-delayed, from the disconnected position T into the closed position S. Due to this time delay, the prespecified delay time duration DT is being implemented. The delay time duration DT can be changed or adjusted on the relay 40.

In the exemplary embodiment according to FIG. 2, the safety circuit 10 also comprises an indicating means 37 and, for example, a visual indicating means 37, for example a light-emitting diode 42. As illustrated by FIG. 2, the light-emitting diode 42 according to the example is connected parallel to the at least one capacitor 19 in a parallel branch 19. A Zener diode 44 arranged in the parallel branch 43 may be connected in series with the light-emitting diode 42.

As long as the capacitor voltage UC is sufficiently high during the discharge in closed position S of the controlled switch 31, a current flows through the parallel branch 43 and the light-emitting diode 42. If the capacitor voltage UC and thus the electrical charge of the at least one capacitor 19 is sufficiently low upon expiration of the discharge duration ET, the Zener diode 44 blocks and the light-emitting diode 42 extinguishes. Consequently, the end of the discharge duration ET can be indicated to the operator by the extinguishing light-emitting diode 42.

It is understood that, different from the exemplary embodiment according to FIG. 2, another indicating means 37 can also be used.

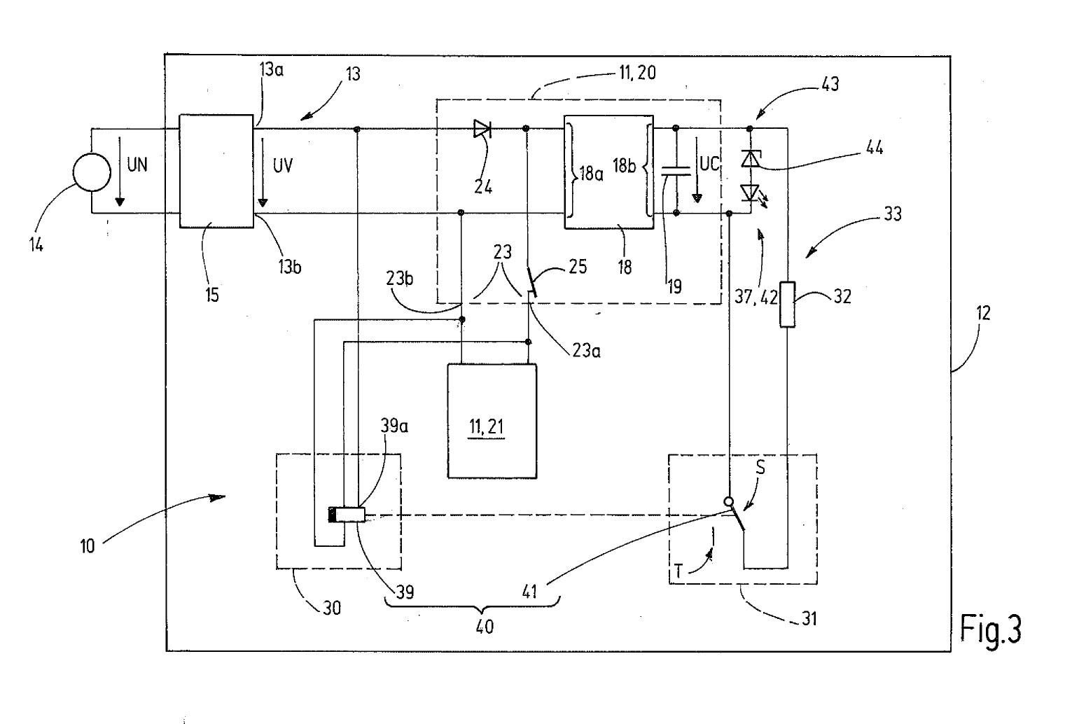

FIG. 3 shows a modification of the second exemplary embodiment according to FIG. 2. The single difference consists in that the control part 39 of the relay 40 has an additional control input 39a that is electrically connected to the first power supply input 13, and in accordance with the example, to the first power supply connection 13a. While the two other connections of the control part 39 in the previous exemplary embodiments were in each case connected to a power supply connection 13a and 13b, respectively, these now are connected to the output connections 23a, 23b of the voltage supply device 20. The supply voltage UV is applied to these connections only when the load switch 25 is closed. Independent of the position of the load switch 25, the controlled switch 31 that is represented by the operating contacts 41 of the relay 40 is switched into its closed position S for discharging the at least one capacitor 19 only when the supply voltage UV is no longer applied to the control input 39a and when the switching condition B, i.e., the prespecified delay time duration DT, has expired. In this exemplary embodiment, the delay time duration DT may be equal to zero, provided the supply voltage UV is input with the load switch 25 opened, because—in this case—a further supply of the operating means 11 or the load 21 is not possible anyhow. The function of the safety circuit 10 corresponds to that of the second exemplary embodiment according to FIG. 2, so that reference is made to the description hereinabove.

FIG. 4 shows a block circuit diagram that illustrates a modified embodiment of the voltage supply device 20. The converter 18 of the voltage supply device 20 is configured as a unidirectional converter. It converts the supply voltage UV applied to the first converter connections 18a into an output voltage on the second converter connections 18b, said supply voltage being applied to the at least one capacitor 19. The output 23 of the voltage supply device 20 is connected to the second converter connections 18b. The capacitor voltage UC is applied between the first output connection 23a and the second output connection 23b. Here, the converter 18 may be configured, for example as an AC-DC converter. In this case, the mains voltage UN may be directly applied as the supply voltage UV to the first converter connections 18A.

The safety circuit 10 corresponds to the exemplary embodiments according to FIG. 1 or 2. The indicating means 37 shown in FIG. 2 may also be optionally provided in this exemplary embodiment according to FIG. 4. The function corresponds to that of the embodiments explained hereinabove.

FIG. 5 shows another exemplary embodiment of an operating means 11 that is represented by an electric motor 47. In a manner known per se, the electric motor 47 is associated with an operating capacitor 48 as well as a starting capacitor 49, in which case the starting capacitor 49 is the at least one capacitor 19. A starting switch 50 is connected in series with the starting capacitor 49. The series circuit comprising the starting capacitor 49 and the starting switch 50 are connected in parallel with the operating capacitor 48 and in parallel with a coil of the electric motor 47. As in the two other exemplary embodiments, the electrical discharge circuit 33 comprises the capacitor 19, i.e., the starting capacitor 49, the controlled switch 31 and the discharge resistor 32.

For starting the electric motor 47, the starting switch 50 is closed and the starting capacitor 49 is charged. After the electric motor 47 has started, the starting switch 50 is opened. In so doing, the starting capacitor 49 may be charged fully or partially. This charge on the starting capacitor 49 remains maintained even if the supply voltage UV is switched off. In contrast, the operating capacitor 48 can discharge via the coils of the electric motor 47. Due to the opened starting switch 50, this is not possible for the starting capacitor 49. Therefore, for discharging the starting capacitor 49, the controlled switch 41 is switched into its closed position S analogously to the method described in conjunction with the other exemplary embodiments, so that a discharge current flows across the other discharge resistor 32 and discharges the starting capacitor 49.

In order to also achieve a defined discharging of the operating capacitor 48, it is possible to also switch—at the same time as the controlled switch 31—the load switch 50 into its conductive state so that also the operating capacitor 48 is switched parallel to the starting capacitor 49 in the electrical discharge circuit 33. Other than that, the safety circuit 10 according to FIG. 5 performs the same function as in the exemplary embodiments described hereinabove.

The modifications described hereinafter can be used in all the previously described exemplary embodiments.

It is understood that, in modification of this, it is possible to arrange also other electrical operating means 11, in addition to a voltage supply device 20 and an electric motor 47, in the explosion-proof casing 12. The safety circuit 10 can be used for all electrical operating means 11 that comprise at least one capacitor 19 or that are allocated at least one capacitor 19.

In the exemplary embodiments in the block circuit diagrams, the discharge resistor 32 is illustrated as one component. In the simplest case, the discharge resistor 32 may be a single ohmic resistor. In modification of this, it is also possible to use an arrangement of components that form a discharge resistor 32.

The discharge of the at least one capacitor 19 via the electrical discharge circuit 33 may also be changed as a function of parameters. For example, the discharge current 32 is configured as a temperature-dependent resistor with preferably positive temperature coefficients (PTC) and be thermally coupled with the at least one capacitor 19. If the temperature of the at least one capacitor 19 rises due to a high discharge current, the discharge current can be reduced by a discharge resistor 32 with positive temperature coefficients (PTC) at increasing temperature, which counteracts another temperature increase. As a result of this, an undesirably high temperature of the at least one capacitor 19 can be avoided.

In another exemplary embodiment, the discharge resistor 32 may also be changeable a function of the capacitor voltage UC.

Furthermore, the visual and/or the acoustic indicating means 37 can be used in all the exemplary embodiments. The indicating means 37 and/or the locking means 38 can be activated by the control unit 30 as indicated in FIG. 1. Alternatively, there is the possibility of using the capacitor voltage UC and/or the discharge current through the electrical discharge circuit 33 for the control of the condition of the indicating means 37 and/or the locking means 38.

In modification of FIGS. 2 and 3, it is also possible to connect the indicating means 37 in series with the discharge resistor 32. For example, a light-emitting diode 42 would extinguish whenever there is no longer any discharge current or insufficient discharge current flowing through the discharge current circuit 33.

In another modification of the exemplary embodiments, an additional switching condition B for switching the controlled switch 31 from its disconnected position T into its closed position S may also be omitted. The controlled switch 31 can thus be switched instantaneously into its closed position S after the supply voltage UV is switched off.

The invention relates to a safety circuit 10 for use in an explosion-proof casing 12. The safety circuit 10 is disposed for discharging a capacitor arrangement comprising at least one capacitor 19 that is associated with an electrical operating means 11. The at least one capacitor 19 is discharged, in a defined manner, via the safety circuit 10 through an electrical discharge circuit 33 during a discharge time period ET, after a supply voltage UV on a power supply input 13 is switched off. At the end of the discharge time duration ET, the electrical charge or the electrical energy of the at least one capacitor 19 is sufficiently low, so that an ignition of the potentially explosive atmosphere in the environment of the explosion-proof casing 12 is precluded.

### LIST OF REFERENCE SIGNS

10 Safety circuit
11 Electrical operating means
12 Explosion-proof casing
13 Power supply input
13a First power supply connection
13b Second power supply connection
14 Mains voltage source
15 Enabling device
18 Converter
18a First converter connection
18b Second converter connection
19 Capacitor
20 Voltage supply device
21 Electrical load
22 Input
22a First input connection
22b Second input connection
23 Output
23a First output connection
23b Second output connection
24 Diode
25 Load switch
30 Control unit
31 Controlled switch
32 Discharge resistor
33 Electrical discharge circuit
37 Indicating means
38 Locking means
39 Control part
39a Control input
40 Relay
41 Operating contacts
42 Light-emitting diode
43 Parallel branch
47 Electric motor
48 Operating capacitor
49 Starting capacitor
50 Starting switch
B Switching condition
DT Delay time duration
ET Discharge duration
S Closed position
T Disconnected position
UC Capacitor voltage
UN Mains voltage
UV Supply voltage

1. Safety circuit (10) for an explosion-proof casing (12),
comprising a control unit (30) that is connected to a power supply input (13) at which is made available a supply voltage (UV) for an electrical operating means (11) arranged in the explosion-proof casing (12),
wherein the electrical operating means (11) comprises at least one capacitor (19) that is connected to the power supply input (13) and/or to an electrical operating means (11) and that, with the supply voltage (UV) switched on and/or when switching on or operating the electrical operating means (11), charges to a capacitor voltage (UC),
comprising a series circuit consisting of a controlled switch (31) and a discharge resistor (32), said series circuit being connected to the at least one capacitor (19) and forming an electrical discharge circuit (33) with the at least one capacitor (19),
wherein the controlled switch (31) interrupts the electrical discharge circuit (3) in a disconnected position (T) and closes the electrical discharge circuit (33) in a closed position (S),
wherein the control unit (30) is disposed to switch the controlled switch (31) into the closed position (S) after the supply voltage (UV) is switched off.

2. Safety circuit as in claim 1,
characterized in that the control unit (30) is disposed to switch the controlled switch (31), after the supply voltage (UV) is switched off, into the closed position (S) only when a switching condition (B) has been satisfied.

3. Safety circuit as in claim 2,
characterized in that the switching condition (B) has been satisfied when a prespecified time duration (DT) has expired from the time the supply voltage (UV) was switched off and/or if the operating means (11) sends a feedback signal to the control unit (30), said signal indicating that the operating means (11) no longer requires a supply with electrical energy.

4. Safety circuit as in claim 1,
characterized in that the control unit (30) is disposed to switch the controlled switch (31) into the closed position (S), directly after switching off the supply voltage (UV).

5. Safety circuit as in one of the previous claims
characterized in that the control unit (30) is disposed to switch the controlled switch (31) into the disconnected position (T), directly after switching on the supply voltage (UV).

6. Safety circuit as in one of the previous claims
characterized in that the control unit (30) comprises a control part (39) of a relay (40).

7. Safety circuit as in claim 6,
characterized in that the controlled switch (31) comprises the operating or load contacts (41) of the relay (40), the switching position of said contacts being controlled by the control part (39).

8. Safety circuit as in claim 6 or 7
characterized in that the relay (40) is configured as a time-controlled relay.

9. Safety circuit as in one of the previous claims
characterized in that the at least one capacitor (19) is a component of a voltage supply device (20).

10. Safety circuit as in claim 9,
characterized in that the voltage supply device (20) is configured as an uninterruptible voltage supply, and that the at least one capacitor (19) is configured as an energy buffer storage.

11. Safety circuit as in one of the previous claims
characterized in that the at least one capacitor (19) is associated as a starting capacitor (49) with an electric motor (47).

12. Method for operating a safety circuit (10) for an explosion-proof casing (12) in which is arranged an electrical operating means (11), comprising a control unit (30) connected to a power supply input (13), at least one capacitor (19), a series circuit consisting of a controlled switch (31) and a discharge resistor (32), said series circuit being connected to the at least one capacitor and forming with the at least one capacitor (19) an electrical discharge circuit (33), comprising the following steps:
Making available a supply voltage (UV) to the power supply input (13) or making available a supply voltage to the power supply input (13), and switching or operating the electrical operating means (11) as a result of which the at least one capacitor (19) charges to a capacitor voltage (UC),
Switching the controlled switch (31), after switching off the supply voltage (UV), into a closed position (S) in which said switch closes the electrical discharge circuit (33).

13. Method as in claim 12,
characterized in that the controlled switch (31) is switched, directly after switching on the supply voltage (UV), into a disconnected position (T), in which said switch interrupts the electrical discharge circuit (33).

14. Method as in claim 12 or 13,
characterized in that the controlled switch (31) is switched, directly after switching off the supply voltage (UV), into the closed position (S).

15. Method as in claim 12 or 13,
characterized in that the controlled switch (31), after switching off the supply voltage (UV), will be switched into the closed position (S) only if a switching condition (B) has been satisfied.
